(19) United States
(12) Patent Application Publication
(10) Pub. No.: US 2025/0276942 A1
(43) Pub. Date: Sep. 4, 2025

(54) UREASE INHIBITOR FORMULATION FOR USE IN UREA GRANULATION PROCESS

(71) Applicant: BASF SE, Ludwigshafen (DE)

(72) Inventors: Maarten Staal, Limburgerhof (DE); Markus Schmid, Limburgerhof (DE); Gregor Pasda, Limburgerhof (DE); Uwe Thiel, Limburgerhof (DE); Ulrike Malang, Limburgerhof (DE); Manuel Knauer, Limburgerhof (DE)

(21) Appl. No.: 18/703,962

(22) PCT Filed: Oct. 24, 2022
(86) PCT No.: PCT/EP2022/079516

§ 371 Date: Apr. 23, 2024

(30) Foreign Application Priority Data
Oct. 26, 2021 (EP) 21204746.8

(51) Int. Cl. C05C 9/00; C05G 3/90

(52) U.S. Cl. CPC C05C 9/005; C05G 3/90

(57) ABSTRACT

The present invention relates to a solid composition (1) comprising (A) a mixture comprising N-(n-butyl)thiophosphoric acid triamide (NBPT) and optionally N-(n-propyl)thiophosphoric acid triamide (NPPT); (B) a solvent selected from the group consisting of glycol ether, glycerin ether, and mixtures thereof; and (C) urea, wherein the solid composition (1) is polymer free. Further, the present invention relates to the use of a solvent selected from the group consisting of glycol ether, glycerin ether, C₃-C₁₀-alkanediol, carboxylic acid amide, and mixtures thereof for stabilizing at least one (thio)phosphoric acid triamide in a solid composition (1) comprising a mixture (A) comprising the at least one (thio)phosphoric acid triamide, urea, and the solvent.

The present invention relates to a solid composition (1) comprising (A) a mixture comprising N-(n-butyl)thiophosphoric acid triamide (NBPT) and optionally N-(n-propyl)thiophosphoric acid triamide (NPPT); (B) a solvent selected from the group consisting of glycol ether, glycerin ether, and mixtures thereof; and (C) urea, wherein the solid composition (1) is polymer free. Further, the present invention relates to the use of a solvent selected from the group consisting of glycol ether, glycerin ether, C₃-C₁₀-alkanediol, carboxylic acid amide, and mixtures thereof for stabilizing at least one (thio)phosphoric acid triamide in a solid composition (1) comprising a mixture (A) comprising the at least one (thio)phosphoric acid triamide, urea, and the solvent.

Worldwide, the predominant and further-increasing amount of the nitrogen used for fertilizing is employed in the form of urea or urea-containing fertilizers. Urea itself, however, is a form of nitrogen which is absorbed very little if at all, being hydrolyzed relatively rapidly by the enzyme urease, which is present ubiquitously in the soil, to form ammonia and carbon dioxide. In this process, in certain circumstances, gaseous ammonia is emitted to the atmosphere, and is then no longer available in the soil for the plants, thereby lowering the efficiency of fertilization.

Ammonia volatilization can cause up to 80% loss of total nitrogen input from surface applied urea, depending on weather and soil conditions. Nitrogen losses result in yield reduction at farmer level and pose an environmental challenge. Ammonia volatilization can be reduced by using urease inhibitors. Next to emission reduction, urease inhibitors also improve the nitrogen-use-efficiency, increase yield performance and allow for a higher degree of freedom in fertilizer application strategy for the farmer. It is known that the degree of utilization of the nitrogen when using urea-containing fertilizers can be improved by spreading urea-containing fertilizers together with substances which are able to inhibit or decrease the enzymatic cleavage of urea (for a general review, see Kiss, S. Simihsian, M. (2002) Improving Efficiency of Urea Fertilizers by Inhibition of Soil Urease Activity, ISBN 1-4020-0493-1, Kluwer Academic Publishers, Dordrecht, The Netherlands). Among the most potent known urease inhibitors are N-alkylthiophosphoric acid triamides and N-alkylphosphoric acid triamides, which are described in EP 0119487, for example.

The use of polymers in fertilizer products is increasingly being questioned. In this connection, it is referred to EU regulation “REGULATION (EU) 2019/1009 OF THE EUROPEAN PARLIAMENT AND OF THE COUNCIL” of 5 Jun. 2019, wherein it is disclosed that merely some polymers are acceptable in fertilizer compositions according to EU standards (see page 61, CMC9).

It is advisable to apply the urease inhibitors together with the urea onto or into the soil, since this ensures that the inhibitor comes into contact, together with the fertilizer, with the soil. The urease inhibitor may be incorporated in the urea by, for example, dissolving it into the melt prior to urea granulation or prilling. A process of this kind is described in U.S. Pat. No. 5,352,265, for example. A further option is to apply the urease inhibitor to the urea granules or prills, in the form of a solution, for example.

The storage life of the urease inhibitor is limited. The higher the temperature, the shorter the storage life. If, for example, urea is stored under tropical conditions, a major part of the urease inhibitor has undergone decomposition, generally, after about four weeks of storage. If the urease inhibitor is introduced into the urea melt, the decomposition is less. For the commercialization of the urea stabilized with the urease inhibitor, however, it is often vital to apply the urease inhibitor to urea and to store the treated fertilizer until the time of its spreading to the soil.

NBPT exemplarily is known to degrade when applied to urea (Soares et al, 17th International Nitrogen Workshop, 2012; Cantarella H, Soares JR, SousaRM,Otto R, SequeiraCH. Stability of urease inhibitor added to urea. Melbourne, Australia: 2016 International nitrogen initiative conference: solutions to improve nitrogen use efficiency for the world, 2016; Watson CJ, Akhonzada NA, Hamilton JTG, Matthews DI. Rate and mode of application of the urease inhibitor N-(n-butyl) thiophosphoric triamide on ammonia volatilization from surface-applied urea. Soil Use Management, 2008, 24:246-53). Attempts have been made to increase the shelf life of NBPT on urea. The stability of N-(n-butyl)thiophosphoric acid triamide (NBPT) and N-(n-propyl)thiophosphoric acid triamide (NPPT) on urea can e.g. be improved using stabilizers, as described in WO 2015/001457. There is however still the need of a stable urea-based granular fertilizer composition, which can be applied directly onto the field.

Against this background it has been an object of the present invention to provide a stable, solid urea-based fertilizer composition, preferably a stable solid urea-based granular fertilizer composition. In particular, it has been an object of the present invention to provide a stable solid urea-based fertilizer composition, wherein not only the urea but also the urease inhibitor are stabilized, preferably even under tropical conditions for a sufficient time period. In this connection, a sufficient time period may be seen as e.g. one to three weeks, preferably about two weeks, when applied directly onto the field, since it is assumed that within this time period the nitrogen of urea is sufficiently absorbed into the soil due to at least the morning dew. With regards to storage, a sufficient time period may be seen as e.g. 6 to 24 months, preferably about 12 months.

In addition, it has been an object of this invention is to provide a urea-based fertilizer composition that is free of micro plastics/polymers.

Further, it has been an object of the present invention to stabilize a urea-based fertilizer composition comprising at least one (thio)phosphoric acid triamide.

Further, it has been an object of the present invention to provide a process of manufacturing a stabile urea-based fertilizer composition. It has been a particular object of the present invention to provide a process of manufacturing a urea-based fertilizer composition, wherein the urea-based fertilizer composition even is stable under granulation.

It has surprisingly been found by the inventors of the present invention, that at least one of the above objects can be achieved by a solid composition (1) as claimed. It has further been found by the inventors of the present invention, that using a solvent selected from the group consisting of glycol ether, glycerin ether, C₃-C₁₀-alkanediol, carboxylic acid amide, and mixtures thereof surprisingly stabilizes at least one (thio)phosphoric acid triamide in the presence of urea.

In a first aspect, the present invention therefore relates to a solid composition (1) comprising
(A) a mixture comprising N-(n-butyl)thiophosphoric acid triamide (NBPT) and optionally N-(n-propyl)thiophosphoric acid triamide (NPPT);
(B) a solvent selected from the group consisting of glycol ether, glycerin ether, and mixtures thereof; and
(C) urea,
wherein the solid composition (1) is polymer free.

In the following, preferred embodiments of the components of the solid composition (1) are described in further detail. It is to be understood that each preferred embodiment is relevant on its own as well as in combination with other preferred embodiments.

In a preferred embodiment A1 of the first aspect, the solvent (B) is a glycol ether, preferably selected from the group consisting of diethylene glycol, dipropylene glycol, triethylene glycol, di-ethyleneglycol monobutylether, triethyleneglycol-n-butylether, and mixtures thereof, in particular diethylene glycol.

In a preferred embodiment A2 of the first aspect, the solvent (B) has a flashpoint (determined according to ISO 2719:2016) of more than 130° C., preferably more than 135° C., and in particular more than 140° C.

In a preferred embodiment A3 of the first aspect, the solid composition (1) further comprises (D) at least one amine selected from the group consisting of
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²,
(D4) an amine containing at least one saturated or unsaturated C₈ to C₄₀ alkyl group R²³, and
(D5) a saturated or unsaturated heterocyclic amine which contains at least one oxygen atom as ring atom and which does not contain a further alkoxy group preferably, wherein the at least one amine is
   (D2) an amine containing not more than one amino group and at least three hydroxy-substituted C₂ to C₈, preferably C₂ to C₅, more preferably C₂ to C₃ alkyl groups R²¹, wherein at least one of the groups R²¹ is different to the other groups R²¹, in particular wherein the amine is bis(hydroxyethyl)-isopropanolamine (DEIPA).

In a preferred embodiment A4 of the first aspect, the weight ratio of the solvent (B) to the sum of N-(n-butyl)thiophosphoric acid triamide (NBPT) and N-(n-propyl)thiophosphoric acid triamide (NPPT) is from 1.1:1 to 50:1, preferably from 1.2:1 to 20:1, and in particular from 1.3:1 to 10:1; and/or
wherein the weight ratio of N-(n-butyl)thiophosphoric acid triamide (NBPT) to N-(n-propyl)thiophosphoric acid triamide (NPPT) is from 0.5:1 to 30:1, preferably from 1:1 to 20:1, more preferably from 1.5:1 to 20:1, even more preferably from 2:1 to 10:1, and in particular from 2.5:1 to 5:1; and/or
wherein the solid composition (1) comprises the sum of N-(n-butyl)thiophosphoric acid triamide (NBPT) and N-(n-propyl)thiophosphoric acid triamide (NPPT) in an amount of 100 to 1000 ppm, preferably of 200 to 800 ppm, and in particular of 300 to 600 ppm.

In a second aspect, the present invention relates to the use of a solvent selected from the group consisting of glycol ether, glycerin ether, C₃-C₁₀-alkanediol, carboxylic acid amide, and mixtures thereof for stabilizing at least one (thio)phosphoric acid triamide in a solid composition (1) comprising a mixture (A) comprising the at least one (thio)phosphoric acid triamide, urea, and the solvent, wherein the solid composition (1) is obtained by mixing a composition (2) comprising the solvent and the at least one (thio)phosphoric acid triamide with a composition (3) comprising molten urea and subsequent cooling.

In the following, preferred embodiments of the use are described in further detail. It is to be understood that each preferred embodiment is relevant on its own as well as in combination with other preferred embodiments.

In a preferred embodiment B1 of the second aspect, the composition (2) comprises the at least one (thio)phosphoric acid triamide in an amount of 5 to 60 wt.-%, preferably of 6 to 50 wt.-%, more preferably of 8 to 40 wt.-%, based on the total weight of the composition (2); and/or the solvent in an amount of 40 to 95 wt.-%, preferably of 55 to 94 wt.-%, more preferably of 65 to 92 wt.-%, based on the total weight of the composition (2).

In a preferred embodiment B2 of the second aspect, the solvent is a glycol ether, preferably selected from the group consisting of diethylene glycol, dipropylene glycol, triethylene glycol, di-ethyleneglycol monobutylether, triethyleneglycol-n-butylether, and mixtures thereof, in particular diethylene glycol.

In a preferred embodiment B3 of the second aspect, the solvent has a flashpoint (determined according to ISO 2719:2016) of more than 130° C., preferably more than 135° C., and in particular more than 140° C.

In a preferred embodiment B4 of the second aspect, the mixture (A) comprises at least one (thio)phosphoric acid triamide according to general formula (I)

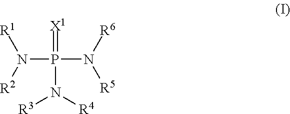

wherein
X¹ is O or S;
R¹ is C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl;
R² is H, C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl; or
R¹ and R² together with the nitrogen atom linking them define a 5- or 6-membered saturated or unsaturated heterocyclic radical, which optionally comprises 1 or 2 further heteroatoms selected from the group consisting of N, O, and S; and
R³, R⁴, R⁵, and R⁶ are independently of each other selected from the group consisting of H and C₁-C₄-alkyl; preferably
wherein the mixture (A) comprises N-(n-butyl)thiophosphoric acid triamide (NBPT) and optionally N-(n-propyl)thiophosphoric acid triamide (NPPT), in particular wherein the mixture (A) comprises N-(n-butyl)thiophosphoric acid triamide (NBPT) and N-(n-propyl)thiophosphoric acid triamide (NPPT).

In a preferred embodiment B5 of the second aspect, at least 50 wt.-%, preferably at least 60 wt.-%, more preferably at least 70 wt.-%, and in particular at least 75 wt.-%, of the at least one (thio)phosphoric acid triamide are stabile over a period of two months storage at 40° C. and/or at least 50 wt.-%, preferably at least 60 wt.-%, more preferably at least 65 wt.-%, and in particular at least 70 wt.-%, of the at least one (thio)phosphoric acid triamide are stabile over a period of six months storage at 30° C.

In a preferred embodiment B6 of the second aspect, the solid composition (1) further comprises
(D) at least one amine selected from the group consisting of
(D1) a polymeric polyamine,
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²,
(D4) an amine containing at least one saturated or unsaturated C₈ to C₄₀ alkyl group R²³, and
(D5) a saturated or unsaturated heterocyclic amine which contains at least one oxygen atom as ring atom and which does not contain a further alkoxy group;
preferably wherein the at least one amine is
   (D2) an amine containing not more than one amino group and at least three hydroxy-substituted C₂ to C₈, preferably C₂ to C₅, more preferably C₂ to C₃ alkyl groups R²¹, wherein at least one of the groups R²¹ is different to the other groups R²¹, in particular wherein the amine is bis(hydroxyethyl)-isopropanolamine (DEIPA).

In a third aspect, the present invention relates to a process of manufacturing a solid composition (1) comprising the steps of
a) dissolving at least one (thio)phosphoric acid triamide in a solvent selected from the group consisting of glycol ether, glycerin ether, C₃-C₁₀-alkanediol, carboxylic acid amide, and mixtures thereof to obtain composition (2);
b) heating urea to a temperature of 125 to 145° C. to obtain composition (3);
c) mixing the composition (2) and the composition (3);
d) cooling the mixture obtained in step c) to a temperature of 20 to 30° C., wherein the cooling is done in a granulation apparatus, a prilling apparatus, pelleting apparatus, a pastilling apparatus or compounding apparatus to form the solid composition (1).

In the following, preferred embodiments of the process are described in further detail. It is to be understood that each preferred embodiment is relevant on its own as well as in combination with other preferred embodiments.

In a preferred embodiment C1 of the third aspect, the mixing in step c) is performed from 1 second to 5 minutes, preferably from 10 seconds to 3 minutes, and in particular from 30 to 90 seconds.

In a preferred embodiment C2 of the third aspect, the solid composition (1) is in the form of granules, prills, pellets, pastilles, or in compounded form, preferably in the form of granules.

In a fourth aspect, the present invention relates to a solid composition (1) obtainable by a process according to the process of the third aspect.

### FIGURES

FIG. 1 depicts NxPT (NPPT and NBPT) recovery of formulations F1 to F5 after two months closed storage at 40° C.

FIG. 2 depicts NxPT recovery of formulations F1 to F5 after six months closed storage at 30° C.

FIG. 3 depicts NxPT recovery of formulations F12 to F14 after two months closed storage at 40° C.

FIG. 4 depicts NxPT recovery of formulations F1, F6, and F7 over six months closed storage at 40° C.

FIG. 5a depicts NxPT recovery of formulations F8 and F9 over 12 months closed storage at 20° C. and over six months closed storage at 30° C.

FIG. 5b depicts NxPT recovery of formulations F8 and F9 over four months closed storage at 40° C.

FIG. 6 depicts NxPT recovery of formulations F10 and F11 over six months closed storage at 30° C.

### DETAILED DESCRIPTION

Before describing in detail exemplary embodiments of the present invention, definitions important for understanding the present invention are given.

As used in this specification and in the appended claims, the singular forms of “a” and “an” also include the respective plurals unless the context clearly dictates otherwise. In the context of the present invention, the terms “about” and “approximately” denote an interval of accuracy that a person skilled in the art will understand to still ensure the technical effect of the feature in question. The term typically indicates a deviation from the indicated numerical value of ±20%, preferably ±15%, more preferably ±10%, and even more preferably ±5%. It is to be understood that the term “comprising” is not limiting. For the purposes of the present invention the term “consisting of” is considered to be a preferred embodiment of the term “comprising of”. If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(a)”, “(b)”, “(c)”, “(d)”, “i”, “ii” etc. relate to steps of a method or use or assay there is no time or time interval coherence between the steps, i.e. the steps may be carried out simultaneously or there may be time intervals of seconds, minutes, hours, days, weeks, months or even years between such steps, unless otherwise indicated in the application as set forth herein above or below. It is to be understood that this invention is not limited to the particular methodology, protocols, reagents etc. described herein as these may vary. It is also to be understood that the terminology used herein is for the purpose of describing particular embodiments only, and is not intended to limit the scope of the present invention that will be limited only by the appended claims. Unless defined otherwise, all technical and scientific terms used herein have the same meanings as commonly understood by one of ordinary skill in the art.

The term “wt.-%” as used throughout herein stands for “percent by weight”.

The terms “does not contain”, “does not comprise”, ‘free of’, and “being [ . . . ]free” as used herein are interchangeable and denote that the component referred to is not comprised in e.g. the respective composition/formulation.

The term “at least one” as used throughout herein above and below means one or more, preferably one or two, and thus typically refers individual compounds or mixtures/combinations.

As used herein, the term “(thio)phosphoric acid triamides” in each case covers thiophosphoric acid triamides and phosphoric acid triamides. Thus, the prefix “(thio)” as used herein in each case indicates that a group P═S or a group P═O is covered. It is noted that the terms “(thio)phosphoric acid triamide” and “(thio)phosphoric triamide” may interchangeably be used.

The organic moieties mentioned in the above definitions of the variables are collective terms for individual listings of the individual group members. The prefix COₙ—Cₘ indicates in each case the possible number of carbon atoms in the group.

The term “alkyl” as used herein denotes in each case a straight-chain or branched alkyl group having usually from 1 to 20 carbon atoms, preferably from 1 to 10 carbon atoms, frequently from 1 to 6 carbon atoms, more preferably 1 to 4 carbon atoms, e.g. 3 or 4 carbon atoms. Examples of alkyl groups are methyl, ethyl, n-propyl, iso-propyl, n-butyl, 2-butyl, iso-butyl, tert-butyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, and 1-ethyl-2-methylpropyl. Preferred alkyl groups are methyl, ethyl, n-propyl, isopropyl, n-butyl, isobutyl, sec-butyl, tert-butyl, n-pentyl, isopentyl, neopentyl, tert-pentyl, hexyl, 2-methylpentyl, n-heptyl, n-octyl, 2-ethylhexyl, isooctyl, nonyl, isononyl, decyl, and isodecyl.

The term “cycloalkyl” as used herein denotes in each case a monocyclic cycloaliphatic radical having usually from 3 to 20 carbon atoms, preferably from 3 to 10 carbon atoms, more preferably from 3 to 6 carbon atoms, such as cyclopropyl, cyclobutyl, cyclopentyl, cyclohexyl, cycloheptyl, cyclooctyl, cyclononyl and cyclodecyl or cyclopropyl, cyclobutyl, cyclopentyl and cyclohexyl.

The term “aryl” includes mono-, bi- or tricyclic aromatic radicals having usually from 6 to 14, preferably 6, 10, or 14 carbon atoms. Exemplary aryl groups include phenyl, naphthyl and anthracenyl. Phenyl is preferred as aryl group.

The term “(di)alkylaminocarbonyl” refers to a (di)alkylamino group, i.e. an amino group comprising 1 or 2 alkyl substituents, which is bonded to the remainder of the molecule via the carbon atom of a carbonyl group (C═O).

The term “alkanediol” as used herein denotes in each case a straight-chain or branched alkyl group having usually from 3 to 10 carbon atoms, preferably from 3 to 8 carbon atoms, having two hydroxyl groups at different carbon atoms, such as 1,3-propanediol, 1,4-butanediol, 1,5-pentandiol, 1,6-hexanediol, 1,7-heptanediol, or 1,8-octanediol.

The term “carboxylic acid amide” as used herein denotes in each case a the condensation product of a carboxylic acid and an amine.

The term “glycol ethers” as used herein refers to ethers comprising 1 to 4 glycol moieties. In certain embodiments, one or more carbon atom(s) of one or more glycol moiety/moieties may further be substituted by C₁-C₄-alkyl, preferably methyl. The glycol ether preferably has a molecular mass of less than 400 g/mol, more preferably less than 300 g/mol, and in particular less than 250 g/mol. In a preferred embodiment, the glycol ether has a molecular mass of 76 to 400 g/mol, preferably of 85 to 300 g/mol, more preferably of 90 to 250 g/mol, and in particular of 95 to 210 g/mol.

The term “glycerin ether” as used herein refers to ethers comprising 1 to 4 glycerin moieties. In certain embodiments, one or more carbon atom(s) of one or more glycerin moiety/moieties may further be substituted by C₁-C₄-alkyl, preferably methyl. The glycerin ether preferably has a molecular mass of less than 450 g/mol, more preferably less than 350 g/mol, and in particular less than 300 g/mol. In a preferred embodiment, the glycol ether has a molecular mass of 106 to 450 g/mol, preferably of 110 to 350 g/mol, more preferably of 120 to 300 g/mol, and in particular of 130 to 250 g/mol.

It is to be understood that, preferably, also stereoisomers, tautomers, N-oxides, and salts of the (thio)phosphoric acid triamide are covered by the term “(thio)phosphoric acid triamide”. Stereoisomers are present, if the compounds contain one or more centers of chirality. In this case, the compounds will be present in the form of different enantiomers or diastereomers, if more than one center of chirality is present. The term “(thio)phosphoric acid triamide” preferably covers every possible stereoisomer, i.e. single enantiomers or diastereomers, as well as mixtures thereof. Tautomers include, e.g., keto-enol tautomers. N-oxides may be formed under oxidative conditions, if tertiary amino groups are present. Salts may be formed, e.g., with the basic amino groups of the (thio)phosphoric acid triamide. Anions, which stem from an acid, with which the (thio)phosphoric acid triamide may have been reacted, are e.g. chloride, bromide, fluoride, hydrogensulfate, sulfate, dihydrogenphosphate, hydrogenphosphate, phosphate, nitrate, bicarbonate, carbonate, hexafluorosilicate, hexafluorophosphate, benzoate, and the anions of C₁-C₄-alkanoic acids, preferably formate, acetate, propionate and butyrate.

The (thio)phosphoric acid triamide according to the invention are preferably solid compounds with a melting point of at least 40° C., preferably at least 50° C., or with a melting point of at least 60° C., preferably at least 80° C., more preferably at least 85° C. Typically, the melting point is at most 200° C., preferably at most 185° C., more preferably at most 150° C., even more preferably at most 120° C., most preferably at most 100° C.

In connection with the melting points as provided herein above and below, it is to be understood that the defined melting points preferably refer to the melting points of the (thio)phosphoric acid triamide in pure form, i.e. not contaminated with impurities of more than 5 wt.-%, preferably not contaminated with impurities of more than 2 wt.-%, and not in the form of a mixture with another (thio)phosphoric acid triamide.

Preferred embodiments regarding the solid composition (1), the use of the specific solvent, and the process of producing a solid composition (1) are described in detail hereinafter. It is to be understood that the preferred embodiments of the invention are preferred alone or in combination with each other.

As indicated above, the present invention relates in one aspect to a solid composition (1) comprising
(A) a mixture comprising N-(n-butyl)thiophosphoric acid triamide (NBPT) and optionally N-(n-propyl)thiophosphoric acid triamide (NPPT);
(B) a solvent selected from the group consisting of glycol ether, glycerin ether, and mixtures thereof; and
(C) urea,
wherein the solid composition (1) is polymer free.

Further disclosed is the solid composition (1) comprising
(A) a mixture comprising N-(n-butyl)thiophosphoric acid triamide (NBPT) and N-(n-propyl)thiophosphoric acid triamide (NPPT);
(B) a solvent selected from the group consisting of glycol ether, glycerin ether, and mixtures thereof; and
(C) urea.

The N-(n-butyl)thiophosphoric acid triamide (NBPT) and optionally N-(n-propyl)thiophosphoric acid triamide (NPPT) applied in the solid composition (1) according to the present invention preferably each have a purity of more than 90%, more preferably more than 95%, and in particular more than 97% or of 90 to 100%, more preferably 95 to 99%, and in particular of 97 to 98%.

In a preferred embodiment, the solvent (B) is a glycol ether, preferably selected from the group consisting of diethylene glycol, dipropylene glycol, triethylene glycol, di-ethyleneglycol monobutylether, triethyleneglycol-n-butylether, and mixtures thereof, more preferably selected from the group consisting of diethylene glycol, dipropylene glycol, and mixtures thereof, and in particular diethylene glycol.

In a preferred embodiment, the solvent (B) has a flashpoint (determined according to ISO 2719:2016) of more than 130° C., preferably more than 135° C., and in particular more than 140° C. The solvent (B) may have a flashpoint (determined according to ISO 2719:2016) of at most 400° C., or of at most 300° C.

In a preferred embodiment, the solvent (B) has a viscosity (determined at 20° C. according to Rotation viscometer; OECD test Guideline 114) of 2 to 60 mPas, preferably of 3 to 45 mPas, and in particular of 4 to 40 mPas.

In a preferred embodiment, the solid composition (1) further comprises
(D) at least one amine selected from the group consisting of
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²,
(D4) an amine containing at least one saturated or unsaturated C₈ to C₄₀ alkyl group R²³, and
(D5) a saturated or unsaturated heterocyclic amine which contains at least one oxygen atom as ring atom and which does not contain a further alkoxy group.

Generally, the at least one amine (D) can be contained in varying amounts in the solid composition (1). Preferably, the amount of (D) is not more than 80 wt.-%, more preferably not more than 60 wt.-%, most preferably not more than 40 wt.-%, most particularly preferably not more than 30 wt.-%, particularly not more than 15 wt.-%, for example not more than 10 wt.-%, based on the total weight of the sum of the at least one amine (D), mixture (A), and the solvent (B). Preferably, the amount of amine (D) is at least 1 wt.-%, more preferably at least 2 wt.-%, most preferably at least 3 wt.-%, most particularly preferably at least 4 wt.-%, particularly at least 5 wt.-%, for example at least 6 wt.-%, based on the total weight of the sum of the at least one amine (D), mixture (A), and the solvent (B).

Further disclosed is (D1) polymeric polyamine, which may be present in a non-polymer free solid composition (1).

Generally, (D1) can be any polymeric polyamine, and is preferably a polyalkyleneimine or polyvinylamine, more preferably a polyalkyleneimine, most preferably a polyethyleneimine, polypropyleneimine, or polybutyleneimine, particularly a polyethyleneimine.

(D1) can be any polymeric polyamine comprising ethyleneimine (—CH2CH2NH—) as monomeric units, including homopolymers and any copolymers of ethyleneimine, and is preferably a homopolymer of ethyleneimine. Copolymers can be alternating, periodic, statistical or block copolymers.

Generally, (D1) can be of any polymer structure, for example a linear polymer, a ring polymer, a cross-linked polymer, a branched polymer, a star polymer, a comb polymer, a brush polymer, a dendronized polymer, or a dendrimer etc. (D1) can be an essentially linear polymer, and is preferably a linear polymer.

Polyethyleneimines which may be used are polyethyleneimine homopolymers which may be present in uncrosslinked or crosslinked form. The polyethyleneimine homopolymers can be prepared by known processes, as described, for example, in Römpps (Chemie Lexikon, 8th edition, 1992, pages 3532-3533), or in Ullmanns Enzyklopädie der Technischen Chemie, 4th edition, 1974, vol. 8, pages 212-213. and the literature stated there. They have a molecular weight in the range from about 200 to 1 000 000 g/mol. Corresponding commercial products are for example available under the name Lupasol® from BASF SE.

The polyethyleneimine (D1) can be a polyethylenimine having a degree of branching in the range of from 0.1 to 0.95 (also referred to as “highly branched polyethyleneimine”), and preferably a polyethylenimine having a degree of branching in the range of from 0.25 to 0.90, more preferably a polyethylenimine having a degree of branching in the range of from 0.30 to 0.80, and most preferably a polyethylenimine having a degree of branching in the range of 0.50 to 0.80.

Highly branched polyethyleneimines are characterized by its high degree of branching, which can be determined for example via ¹³C-NMR spectroscopy, preferably in D₂O, and is defined as follows:

Degree of branching=D+T/D+T+L

D (dendritic) equals the percentage of tertiary amino groups, L (linear) equals the percentage of secondary amino groups, and T (terminal) equals the percentage of primary amino groups.

Generally, the polymeric polyamine (D1) can have different weight average molecular weights. The weight average molecular weight of (D1) is preferably at least 200, more preferably at least 400, most preferably at least 550, particularly at least 650, for example at least 750. The weight average molecular weight of (D1) is preferably not more than 10,000, more preferably not more than 4,000, most preferably not more than 1,900, particularly not more than 1,500, for example not more than 1,350. The weight average molecular weight can be determined by standard gel permeation chromatography (GPC) known to the person skilled in the art.

In connection with polymeric amines, polyalkyleneimine or polyvinylamine, more preferably a polyalkyleneimine, most preferably a polyethyleneimine, polypropyleneimine, or polybutyleneimine shall be named.

According to another embodiment, (D) is (D2) an amine containing not more than one amino group and at least three alkoxy- or hydroxy-substituted C₂ to C₁₂ alkyl groups R²¹, wherein at least one of the groups R²¹ is different to the other groups R²¹.

A number of groups R²¹ within (D2) is at least 3, preferably 3 to 5, more preferably 3 to 4, and most preferably 3.

The number of carbon atoms in each group R²¹ within (D2) is 2 to 12, preferably 2 to 9, more preferably 2 to 7, most preferably 2 to 5, particularly preferably 2 to 4, particularly 2 to 3, for example 3, wherein said number of carbon atoms does not include carbon atoms in any alkoxy groups or any other substituents of R²¹.

The groups R²¹ within (D2) are alkoxy- or hydroxy-substituted, preferably hydroxy-substituted.

For one amine (D2), among the at least three groups R²¹, at least one of the groups R²¹ is different to the other groups R²¹, preferably one of the groups R²¹ is different to the other groups R²¹.

Preferably at least one of the groups R²¹, more preferably at least two of the groups R²¹, most preferably at least three of the groups R²¹, particularly all groups R²¹ is or are covalently bound to the amino group of the amine (D2).

According to another preferred embodiment, (D2)
is an amine containing not more than one amino group and at least three hydroxy-substituted C₂ to C₈—or preferably C₂ to C₅— alkyl groups R²¹, wherein at least one of the groups R²¹ is different to the other groups R²¹,
is preferably an amine containing not more than one amino group and at least three hydroxy-substituted C₂ to C₃ alkyl groups R²¹, wherein at least one of the groups R²¹ is different to the other groups R²¹,
is more preferably an amine containing not more than one amino group and three hydroxy-substituted C₂ to C₃ alkyl groups R²¹ which are covalently bound to the amino group, wherein one of the groups R²¹ is different to the other groups R²¹, and
is for example an amine selected from the group consisting of Bis(hydroxyethyl)-isopropanolamine (DEIPA), and 1,1′-((2-Hydroxyethyl)imino)dipropan-2-ol.

According to another preferred embodiment, (D2) is an amine N(R²¹)₃ wherein R²¹ is a an alkoxy- or hydroxy-substituted—preferably a hydroxyl-substituted—C₂ to C₁₂— preferably a C₂ to C₇, more preferably a C₂ to C₃— alkyl group and wherein one of the groups R²¹ is different to the other group R²¹.

According to another preferred embodiment, (D2) is an amine N(R²¹)₃ wherein R²¹ is a an alkoxy- or hydroxy-substituted—preferably a hydroxyl-substituted —C₂ to C₁₂—preferably a C₂ to C₇, more preferably a C₂ to C₃—alkyl group and wherein one of the groups R²¹ is different to the other group R²¹ and wherein at least one of the groups R²¹ bears the alkoxy or hydroxy substituent at a secondary or tertiary carbon atom.

According to another embodiment, (D) is (D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²².

A number of groups R²² within (D3) is at least 2, preferably 2 to 5, more preferably 2 to 4, and most preferably 2 to 3, for example 2.

The number of carbon atoms in each group R²² within (D3) is 2 to 12, preferably 2 to 9, more preferably 2 to 7, most preferably 2 to 5, particularly preferably 2 to 4, particularly 2 to 3, for example 3, wherein said number of carbon atoms does not include carbon atoms in any alkoxy groups or any other substituents of R²².

The groups R²² within (D3) are alkoxy- or hydroxy-substituted, preferably hydroxy-substituted.

For one amine (D3), among the at least two groups R²², at least one of the groups R²² is different to the other group(s) R²², preferably one of the groups R²² is different to the other group(s) R²².

Preferably at least one of the groups R²², more preferably at least two of the groups R²², most preferably all groups R²² is or are covalently bound to the amino group of the amine (D3).

Preferably at least one of the groups R²², more preferably one of the groups R²² bears the alkoxy or hydroxy substituent at a secondary or tertiary carbon atom, particularly at a secondary carbon atom.

According to another preferred embodiment, (D3)
is an amine containing not more than one amino group and at least two hydroxy-substituted C₂ to C₇ alkyl groups R²², wherein at least one of the groups R²² bears the hydroxy substituent at a secondary or tertiary carbon atom and wherein at least one of the groups R²² is different to the other group(s) R²²,
is more preferably an amine containing not more than one amino group and at least two hydroxy-substituted C₂ to C₄ alkyl groups R²², wherein at least one of the groups R²² bears the hydroxy substituent at a secondary carbon atom and wherein at least one of the groups R²² is different to the other group(s) R²²,
is most preferably an amine containing not more than one amino group and two hydroxy-substituted C₂ to C₃ alkyl groups R²² which are covalently bound to the amino group of the amine (D3), wherein at least one of the groups R²² bears the hydroxy substituent at a secondary carbon atom and wherein one of the groups R²² is different to the other group R²²,
is for example an amine selected from the group consisting of 1-((2-hydroxyethyl)amino)-propan-2-ol, and N-Methyl-N-hydroxyethyl-isopropanolamine.

According to another preferred embodiment, (D3) is an amine R²⁴N(R²²)₂ wherein R²⁴ is H or a C₁ to C₁₂—preferably a C₁ to C₇, more preferably a C₁ to C₃—alkyl group and R²² is an alkoxy- or hydroxy-substituted—preferably a hydroxyl-substituted —C₂ to C₁₂—preferably a C₂ to C₇, more preferably a C₂ to C₃—alkyl group and wherein at least one of the groups R²² bears the hydroxy substituent at a secondary carbon atom and wherein one of the groups R²² is different to the other group R²².

According to another embodiment, (D) is (D4) an amine containing at least one saturated or unsaturated C₈ to C₄₀ alkyl group R²³.

The number of carbon atoms in each group R²³ within (D4) is 8 to 40, preferably 8 to 32, more preferably 8 to 24, most preferably 8 to 19, particularly preferably 8 to 16.

The group R²³ within (D4) is saturated or unsaturated, preferably unsaturated.

According to another preferred embodiment, (D4) contains at least one alkoxy or hydroxy group, more preferably at least one alkoxy and at least one hydroxy groups, most preferably at least two alkoxy and at least one hydroxyl group, particularly at least four alkoxy and at least one hydroxyl group.

For example, (D4) is an amine selected from the group consisting of: ethoxylated (2) cocoalkylamine, ethoxylated (5) cocoalkylamine, ethoxylated (15) cocoalkylamine, ethoxylated (2) oleylamine, lauryl-dimethylamine, oleyl-dimethylamine, and 2-propylheptylamine ethoxylate (5 EO), 2-propylheptylamine ethoxylate (10 EO), and 2-propylheptylamine ethoxylate (20 EO).

According to another embodiment, (D) is (D5) a saturated or unsaturated heterocyclic amine which contains at least one oxygen atom as ring atom and which does not contain a further alkoxy group.

The term “heterocyclic amine” stands for a heterocyclic compound in which at least one ring atom of the heterocyclic ring is a nitrogen atom.

The heterocyclic amine (D5) is saturated or unsaturated, preferably saturated.

The heterocyclic amine (D5) contains preferably a 5-, 6- or 7-membered heterocyclic ring, more preferably a 5- or 6-membered ring, most preferably a 6-membered ring.

The heterocyclic amine (D5) contains at least one, more preferably 1 to 3, most preferably 1 to 2, particularly one oxygen atom(s) as ring atom(s) of the heterocyclic ring.

The heterocyclic amine (D5) is preferably a morpholine or morpholine derivative, more preferably N-alkyl morpholine, most preferably N-methyl, N-ethyl, N-propyl, or N-butyl morpholine, for example N-methyl morpholine.

The at least one amine is not a polymeric polyamine.

It is particularly preferred that, if present, the at least one amine (D) is (D2) an amine containing not more than one amino group and at least three hydroxy-substituted C₂ to C₈, preferably C₂ to C₅, more preferably C₂ to C₃ alkyl groups R²¹, wherein at least one of the groups R²¹ is different to the other groups R²¹, in particular wherein the amine is bis(hydroxyethyl)-isopropanolamine (DEIPA).

The solid composition (1) is polymer free.

In a preferred embodiment, the solid composition (1) does not comprise dimethyl sulfoxide. Without being bound to any theory, it is assumed that formulations that do not comprise dimethyl sulfoxide have a reduced odor nuisance. Such formulations hence provide a sufficient fertilizer formulation having a reduced odor nuisance. In a further preferred embodiment, the solid composition (1) does not comprise N,N-dimethyl lactamide. In a further preferred embodiment, the solid composition (1) does not comprise 1,2-propylene glycol.

In a preferred embodiment, the mixture (A) and the solvent (B) are not coated onto the urea. In this connection, it is to be understood that the ingredients of the solid composition (1), e.g. the mixture (A), the solvent (B), and the urea are homogenously distributed.

In a preferred embodiment, the weight ratio of the solvent (B) to the sum of N-(n-butyl)thiophosphoric acid triamide (NBPT) and N-(n-propyl)thiophosphoric acid triamide (NPPT) is from 1.1:1 to 50:1, preferably from 1.2:1 to 20:1, and in particular from 1.3:1 to 10:1. In a specific preferred embodiment, wherein the solid composition (1) does not comprise least one amine (D), the weight ratio of the solvent (B) to the sum of N-(n-butyl)thiophosphoric acid triamide (NBPT) and N-(n-propyl)thiophosphoric acid triamide (NPPT) is from 1.3:1 to 50:1, preferably from 1.5:1 to 40:1, more preferably from 1.8:1 to 30:1, even more prefer-ably from 2:1 to 20:1, and in particular from 2.5:1 to 10:1. In another specific preferred embodiment, wherein the solid composition (1) does comprise least one amine (D), the weight ratio of the solvent (B) to the sum of N-(n-butyl)thiophosphoric acid triamide (NBPT) and N-(n-propyl)thiophosphoric acid triamide (NPPT) is from 1.1:1 to 30:1, preferably from 1.2:1 to 10:1, and in particular from 1.3:1 to 5:1.

In a preferred embodiment, the weight ratio of N-(n-butyl)thiophosphoric acid triamide (NBPT) to N-(n-propyl)thiophosphoric acid triamide (NPPT) is from 0.5:1 to 30:1, preferably from 1:1 to 20:1, more preferably from 1.5:1 to 20:1, even more preferably from 2:1 to 10:1, and in particular from 2.5:1 to 5:1.

In a preferred embodiment, the solid composition (1) comprises the sum of N-(n-butyl)thiophosphoric acid triamide (NBPT) and N-(n-propyl)thiophosphoric acid triamide (NPPT) in an amount of 100 to 1000 ppm, preferably of 200 to 800 ppm, and in particular of 300 to 600 ppm.

If present, the weight ratio of the at least one amine (D) to the sum of N-(n-butyl)thiophosphoric acid triamide (NBPT) and N-(n-propyl)thiophosphoric acid triamide (NPPT) is preferably from 1:50 to 1:1, more preferably from 1:30 to 1:2, even more preferably from 1:20 to 1:4, and in particular from 1:15 to 1:5.

The solid composition (1) according to the present invention may further comprise components, such as a conditioning agent, an anti-caking agent, a pigment, a dye, formaldehyde, urea formaldehyde, and combinations thereof. In this connection, it is to be understood that urea formaldehyde is the reaction product of urea and formaldehyde (also known as UF).

Examples of a conditioning agent include, but are not limited to mineral oil and the like. In some embodiments, the conditioning agent is added to the solid composition (1) after it is solidified into granules, prills, etc. In one embodiment, the conditioning agent is combined with the solid composition (1) in a ratio of about 3:1 solid composition (1) to conditioning agent.

Examples of an anti-caking agent include, but are not limited to lime, gypsum, silicon dioxide, kaolinite, or polyvinyl alcohol (PVA).

The pigments or dyes can be any available color are typically considered non-hazardous. In some embodiments, the dye is present in less than about 1 wt.-%, or less than about 2 wt.-%, or less than about 3 wt.-%, or of about 1 to 2 wt.-%, based on the total amount of the solid composition (1).

The solid composition (1) according to the present invention preferably has a pH of 7 to 12, more preferably of 7 to 11, still more preferably of 8 to 11 or of 7.5 to 10.5, and in particular of 8 to 10.

As mentioned above, the invention further relates in a second aspect to the use of a solvent selected from the group consisting of glycol ether, glycerin ether, C₃-C₁₀-alkanediol, carboxylic acid amide, and mixtures thereof for stabilizing at least one (thio)phosphoric acid triamide in a solid composition (1) comprising a mixture (A) comprising the at least one (thio)phosphoric acid triamide, urea, and the solvent, wherein the solid composition (1) is obtained by mixing a composition (2) comprising the solvent and the at least one (thio)phosphoric acid triamide with a composition (3) comprising molten urea and subsequent cooling.

It is to be understood that all definitions and preferred embodiments as described above shall also hold for the use of the specific solvent. Further preferred embodiments are described in detail herein after.

The composition (2) according to the present invention is understood to be a urease inhibitor formulation.

In a preferred embodiment, the composition (2) comprises the at least one (thio)phosphoric acid triamide in an amount of 5 to 60 wt.-%, preferably of 6 to 50 wt.-%, more preferably of 8 to 40 wt.-%, based on the total weight of the composition (2). In one preferred embodiment of the present invention, the composition (2) comprises the at least one (thio)phosphoric acid triamide in an amount of 5 to 40 wt.-%, preferably of 10 to 30 wt.-%, based on the total weight of the composition (2), preferably wherein the composition (2) does not comprises at least one amine (D). In another embodiment of the present invention, the composition (2) comprises the at least one (thio)phosphoric acid triamide in an amount of 20 to 60 wt.-%, preferably of 30 to 50 wt.-%, based on the total weight of the composition (2), preferably wherein the composition (2) further comprises at least one amine (D).

In a preferred embodiment, the composition (2) comprises the solvent in an amount of 40 to 95 wt.-%, preferably of 55 to 94 wt.-%, more preferably of 65 to 92 wt.-%, based on the total weight of the composition (2). In one preferred embodiment of the present invention, the composition (2) comprises the solvent in an amount of 50 to 95 wt.-%, preferably of 60 to 92 wt.-%, based on the total weight of the composition (2), preferably wherein the composition (2) does not comprises at least one amine (D). In another embodiment of the present invention, the composition (2) comprises the solvent in an amount of 40 to 70 wt.-%, preferably of 45 to 60 wt.-%, based on the total weight of the composition (2), preferably wherein the composition (2) further comprises at least one amine (D).

If present, the composition (2) preferably comprises the at least one amine (D) in an amount of 1 to 60 wt.-%, more preferably of 2 to 40 wt.-%, even more preferably of 3 to 20 wt.-%, and in particular of 4 to 10 wt.-%, based on the total weight of the composition (2).

Preferably, the composition (2) has a viscosity (determined at 20° C. according to Rotation viscometer; OECD test Guideline 114) of 2 to 150 mPas, more preferably of 10 to 130 mPas, even more preferably of 15 to 120 mPas, and in particular of 30 to 100 mPas.

Preferably, the composition (2) has a density (determined according to EEC method A3. 1.4.3; OECD test Guideline 109) of 0.9 to 1.4 g/mL, more preferably of 1.0-1.3 g/mL, and in particular of 1.1-1.2 g/mL.

In a preferred embodiment, composition (2) is free of urea.

In a preferred embodiment, the solvent is a glycol ether, preferably selected from the group consisting of diethylene glycol, dipropylene glycol, triethylene glycol, di-ethyleneglycol monobutylether, triethyleneglycol-n-butylether, and mixtures thereof, more preferably selected from the group consisting of diethylene glycol, dipropylene glycol, and mixtures thereof, and in particular diethylene glycol.

In a preferred embodiment, the solvent has a flashpoint (determined according to ISO 2719:2016) of more than 130° C., preferably more than 140° C., and in particular more than 145° C.

In a preferred embodiment, the mixture (A) comprises at least one (thio)phosphoric acid triamide according to general formula (I)

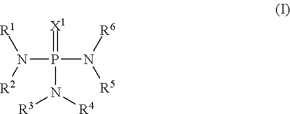

wherein
X¹ is O or S;
R¹ is C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl;
R² is H, C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl; or
R¹ and R² together with the nitrogen atom linking them define a 5- or 6-membered saturated or unsaturated heterocyclic radical, which optionally comprises 1 or 2 further heteroatoms selected from the group consisting of N, O, and S; and
R³, R⁴, R⁵, and R⁶ are independently of each other selected from the group consisting of H and C₁-C₄-alkyl.

In a preferred embodiment of the invention the mixture (A) comprises at least one (thio)phosphoric acid triamide according to general formula (I)

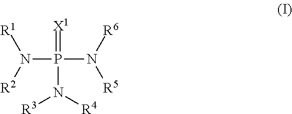

wherein
X¹ is O or S;
R¹ is C₁-C₈-alkyl, C₅-C₆-cycloalkyl, phenyl, or benzyl;
R² is H, or C₁-C₄-alkyl; and
R³, R⁴, R⁵, and R⁶ are each H

Particularly preferably, the mixture (A) comprises at least one (thio)phosphoric acid triamide according to general formula (I),
wherein
X¹ is S;
   R¹ is C₁-C₈-alkyl, C₅-C₆-cycloalkyl, phenyl, or benzyl;
   R² is H or C₁-C₄-alkyl; and
   R³, R⁴, R⁵, and R⁶ are each H;
and wherein most preferably
X¹ is S;
   R¹ is C₁-C₅-alkyl;
   R² is H or C₁-C₄-alkyl; and
   R³, R⁴, R⁵, and R⁶ are each H.

In one preferred embodiment of the invention, the at least one (thio)phosphoric acid triamide has a melting point of at least 40° C., preferably at least 50° C., more preferably at least 60° C., most preferably at least 80° C., particularly preferably at least 85° C.

Preferred (thio)phosphoric acid triamides with a melting point of at least 40° C. are selected from the group consisting of

N-benzyl-N-methylthiophosphoric acid triamide, N,N-diethylthiophosphoric acid triamide, N-(n-butyl)thiophosphoric acid triamide, N-isopropylphosphoric acid triamide, N-(n-hexyl)thio-phosphoric acid triamide, N-(sec-butyl)thiophosphoric acid triamide, N,N-diethylphosphoric acid triamide, N-(n-propyl)thiophosphoric acid triamide, N,N-diisopropylthiophosphoric acid triamide, N,N-dimethylthiophosphoric acid triamide, N-(n-octyl)phosphoric acid triamide, N-(n-butyl)-phosphoric acid triamide, N-cyclohexylphosphoric acid triamide, N-benzyl-N-methylphosphoric acid triamide, N,N-dimethylphosphoric acid triamide, and N-cyclohexylthiophosphoric acid triamide.

In one preferred embodiment, the mixture (A) comprises at least two (thio)phosphoric acid triamides. In a preferred embodiment, the mixture (A) comprises the at least two (thio)phosphoric acid triamides having the general formula (I) as above-outlined. In this connection, it is to be understood that the at least two (thio)phosphoric acid triamides are structurally different, e.g. have at least one different moiety according to general formula (I) as above-outlined.

It may be that the mixture (A) comprises at least N-(n-propyl)thiophosphoric acid triamide (NPPT).

In a preferred embodiment, the mixture (A) comprises at least N-(n-butyl)thiophosphoric acid triamide (NBPT).

In a particular preferred embodiment, the mixture (A) comprises N-(n-butyl)thiophosphoric acid triamide (NBPT) and optionally N-(n-propyl)thiophosphoric acid triamide (NPPT), in particular wherein the mixture (A) comprises N-(n-butyl)thiophosphoric acid triamide (NBPT) and N-(n-propyl)thiophosphoric acid triamide (NPPT).

In one preferred embodiment, at least 50 wt.-%, preferably at least 60 wt.-%, more preferably at least 70 wt.-%, and in particular at least 75 wt.-%, of the at least one (thio)phosphoric acid triamide are stabile over a period of two months storage, preferably closed storage, at 40° C.

In one preferred embodiment, at least 30 wt.-%, preferably at least 35 wt.-%, and in particular at least 40 wt.-%, of the at least one (thio)phosphoric acid triamide are stabile over a period of six months storage, preferably closed storage, at 40° C.

In a particularly preferred embodiment, at least 40 wt.-%, preferably at least 50 wt.-%, more preferably at least 60 wt.-%, and in particular at least 70 wt.-%, of the at least one (thio)phosphoric acid triamide are stabile over a period of four months storage, preferably closed storage, at 40° C.

In one preferred embodiment, at least 50 wt.-%, preferably at least 60 wt.-%, more preferably at least 65 wt.-%, and in particular at least 70 wt.-%, of the at least one (thio)phosphoric acid triamide are stabile over a period of six months storage, preferably closed storage, at 30° C.

In a particularly preferred embodiment, at least 60 wt.-%, preferably at least 70 wt.-%, more preferably at least 80 wt.-%, and in particular at least 85 wt.-%, of the at least one (thio)phosphoric acid triamide are stabile over a period of six months storage, preferably closed storage, at 30° C.

In one preferred embodiment, at least 70 wt.-%, preferably at least 80 wt.-%, more preferably at least 85 wt.-%, and in particular at least 90 wt.-%, of the at least one (thio)phosphoric acid triamide are stabile over a period of 12 months storage, preferably closed storage, at 20° C.

The above outlined stabilities may e.g. be determined by dissolving 2×15 g in 100 mL water and analyze the sample using HPLC method DIN_EN_16651 using the mean value.

In one preferred embodiment, the solid composition (1) further comprises
(D) at least one amine selected from the group consisting of
(D1) a polymeric polyamine,
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²,
(D4) an amine containing at least one saturated or unsaturated C₈ to C₄₀ alkyl group R²³, and
(D5) a saturated or unsaturated heterocyclic amine which contains at least one oxygen atom as ring atom and which does not contain a further alkoxy group;
preferably wherein the at least one amine is
(D2) an amine containing not more than one amino group and at least three hydroxy-substituted C₂ to C₈, preferably C₂ to C₅, more preferably C₂ to C₃ alkyl groups R²¹, wherein at least one of the groups R²¹ is different to the other groups R²¹, in particular wherein the amine is bis(hydroxyethyl)-isopropanolamine (DEIPA).

In a preferred embodiment, the solid composition (1) is polymer free.

In a preferred embodiment, the solid composition (1) does not comprise dimethyl sulfoxide.

In a further preferred embodiment, the solid composition (1) does not comprise N,N-dimethyl lactamide. In a further preferred embodiment, the solid composition (1) does not comprise 1,2-propylene glycol.

In a preferred embodiment, the mixture (A) and the solvent are not coated onto the composition (3). In this connection, it is to be understood that the ingredients of the solid composition (1), e.g. the mixture (A), the solvent, and the composition (3) are homogenously distributed.

As mentioned above, the invention further relates in a third aspect to a process of manufacturing a solid composition (1) comprising the steps of
a) dissolving at least one (thio)phosphoric acid triamide in a solvent selected from the group consisting of glycol ether, glycerin ether, C₃-C₁₀-alkanediol, carboxylic acid amide, and mixtures thereof to obtain composition (2);
b) heating urea to a temperature of 125 to 145° C. to obtain composition (3);
c) mixing the composition (2) and the composition (3);
d) cooling the mixture obtained in step c) to a temperature of 20 to 30° C., wherein the cooling is done in a granulation apparatus, a prilling apparatus, pelleting apparatus, a pastilling apparatus or compounding apparatus to form the solid composition (1).

It is to be understood that all definitions and preferred embodiments as described above shall also hold for the process of manufacturing a solid composition (1). Further preferred embodiments are described in detail herein after.

It is to be understood that the term “dissolving” in step a) denotes that a clear solution is achieved. In case the ingredients in step a) cannot be dissolved under room temperature conditions, the mixture can be heated to a temperature up to e.g. 70° C., preferably up to 60° C., or to a range of 40 to 70° C., preferably of 45 to 60° C. Dissolving may also be obtained via stirring or via a combination of heating and stirring.

In a preferred embodiment, the urea is mixed with water prior the heating in step b). Water may be added by an amount of 0.1 to 6.0 wt.-%, preferably of 0.5 to 5.0 wt.-%, and in particular of 1.0 to 4.0s wt.-%, based on the sum of urea and water.

In one preferred embodiment, the mixing in step c) is performed from 1 second to 5 minutes, preferably from 10 seconds to 3 minutes, more preferably from 30 to 90 seconds, and in particular from 40 to 70 seconds or 40 to 60 seconds.

In one preferred embodiment, the solid composition (1) is in the form of granules, prills, pellets, pastilles, or in compounded form, preferably in the form of granules.

Preferably, the solid composition (1) is in the form homogeneous granules, homogeneous prills, homogeneous pellets, homogeneous pastilles, or in homogeneous compounded form, more preferably in form of homogeneous granules.

Preferably, the size of the solid composition (1) obtained according to the inventive process ranges from about 0.5 millimeters to about 10 millimeters, and more preferably from about 0.84 millimeters to about 4.76 millimeters, wherein preferably the solid composition (1) is in form of granules.

In a preferred embodiment of the invention, particles, preferably granules, which pass through a 4 mesh Tyler Series sieve (about 4.76 millimeters) and stay on a 20 mesh Tyler Series sieve (about 0.84 millimeters) are retained as product. The undersized particles are cooled and recycled and the oversized particles are cooled, ground and then recycled to the urea melt or the cooling apparatus, preferably the granulation apparatus.

In one preferred embodiment, the process further comprises adding a dye prior to cooling step d).

In one preferred embodiment, step a) comprises dissolving at least two (thio)phosphoric acid triamides in the solvent, preferably wherein the at least two (thio)phosphoric acid triamides have the general formula (I) as above-outlined. In this connection, it is to be understood that the at least two (thio)phosphoric acid triamides are structurally different, e.g. have at least one different moiety according to general formula (I) as above-outlined.

It may be that the solid composition (2) comprises at least N-(n-propyl)thiophosphoric acid triamide (NPPT).

In a preferred embodiment, the solid composition (2) comprises at least N-(n-butyl)thiophosphoric acid triamide (NBPT).

In a particular preferred embodiment, the solid composition (2) comprises N-(n-butyl)thiophosphoric acid triamide (NBPT) and optionally N-(n-propyl)thiophosphoric acid triamide (NPPT), in particular wherein the solid composition (2) comprises N-(n-butyl)thiophosphoric acid triamide (NBPT) and N-(n-propyl)thiophosphoric acid triamide (NPPT).

In a preferred embodiment, composition (2) is free of urea.

In a preferred embodiment, the solid composition (1) is polymer free.

In a preferred embodiment, the solid composition (1) does not comprise dimethyl sulfoxide.

In a further preferred embodiment, the solid composition (1) does not comprise N,N-dimethyl lactamide. In a further preferred embodiment, the solid composition (1) does not comprise 1,2-propylene glycol.

In a preferred embodiment, the mixture (A) and the solvent are not coated onto the composition (3). In this connection, it is to be understood that the ingredients of the solid composition (1), e.g. the mixture (A), the solvent, and the composition (3) are homogenously distributed.

As mentioned above, the invention further relates in a fourth aspect to a solid composition (1) obtainable by a process as outlined in more detail above.

It is to be understood that all definitions and preferred embodiments as described above shall also hold for the a solid composition (1) obtainable by the herein disclosed process.

The present invention is further illustrated by the following examples.

### EXAMPLES

### Materials

| | | Flashpoint |
|---|---|---|
| Material | Chemical name | (° C.) |
| Piagran 46 | Urea | — |
| NBPT | n-butylthiophosphoric triamide | — |
| NPPT | n-propylthiophosphoric triamide | — |
| DEG | Diethylene glycol | 142 |
| DPG | Dipropylene glycol | 130 |
| DMSO | Dimehtyl sulfoxide | 95 |
| PG | Propylene glycol | 99 |
| PEI | Polyethyleneimine | 180 |
| DEIPA | Diethanol isopropanol amine | 191 |
| Agnique AMD 3L | N,N-Dimethyl lactamide | 103 |

### Example 1

Formulations of NBPT and NPPT in different solvents were prepared as shown in Table 1 below. In case the active ingredient did not dissolve at room temperature (example F7), the mixture was heated to 50° C. and stirred until a clear solution was achieved.

TABLE 1
Ingredients of urease inhibitor formulation.

| | Formulation composition (g) | | | | | | |
|---|---|---|---|---|---|---|---|
| | | | | | | | Agnique |
| | NBPT | NPPT | DEG | DPG | PG | DMSO | AMD 3L |
| F1 | 18.75 | 6.25 | 75 | | | | |
| F2 | 18.75 | 6.25 | | 75 | | | |
| F3 | 18.75 | 6.25 | | | 75 | | |
| F4 | 18.75 | 6.25 | | | | 75 | |
| F5 | 18.75 | 6.25 | | | | | 75 |
| F6 | 7.5 | 2.5 | 90 | | | | |
| F7 | 37.5 | 12.5 | 50 | | | | |
| F12 | 25 | | 75 | | | | |
| F13 | 25 | | | | 75 | | |
| F14 | 25 | | | | | 75 | |

### Example 2

900 g urea+20 mL water were added to a metal pan and heated to 135° C.+1−5° C. under continuous stirring using an overhead stirrer. When all urea was melted, the respective amount of urease inhibitor formulation was added to the urea melt to achieve an NxPT (i.e. NBPT and NPPT) concentration of 550 ppm in urea. After 1 minute of mixing, the molten urea was poured onto an aluminum tray and let cool down at room temperature for 30 min. Afterwards, the urea was broken up in pieces of 1-6 mm and stored in closed polyethylene bottles at 30° C. and 40° C. After 2 and 6 months samples were taken and analyzed for active ingredient concentration. From each sample 2×15 g was dissolved in 100 mL water and analyzed using HPLC method DIN_EN_16651. The resulting NxPT concentrations from both measurements were averaged.

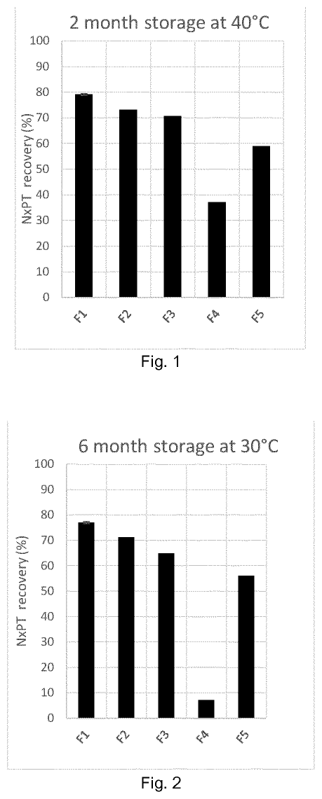

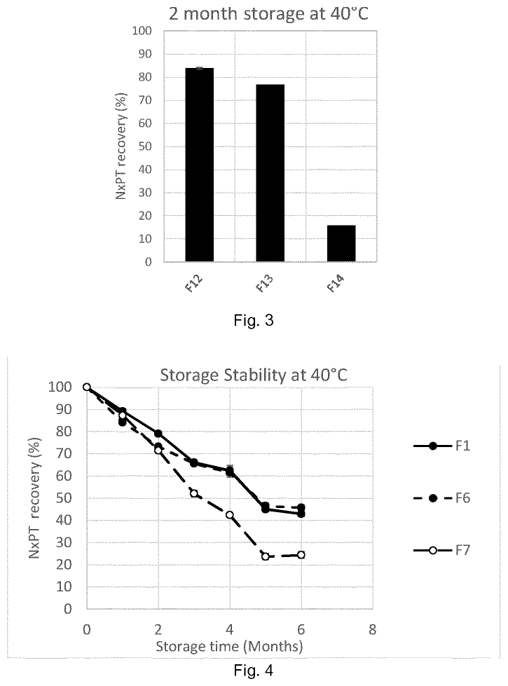

The results in the graphs of FIGS. 1, 2, and 3 surprisingly show that the solvents used in the urease inhibitor formulations F1-F5 and F12-F14 have an influence on the stability of NxPT (i.e. NBPT and optionally NPPT) during storage of the treated urea. Among the tested glycols, diethylene glycol (DEG) proved to have the best stabilizing properties. The stabilizing properties of the tested solvents are ranked as follows: DEG>DPG>PG>N,N-Agnique AMD 3L>DMSO.

### Example 3

900 g urea+20 mL water were added to a metal pan and heated to 135° C.+/−5° C. under continuous stirring using an overhead stirrer. When all urea was melted, the respective amount of urease inhibitor formulation was added to the urea melt to achieve a NxPT concentration of 550 ppm (137.5 ppm NPPT and 412.5 ppm NBPT) in urea. After 1 minute of mixing, the molten urea was poured onto an aluminum tray and let cool down at room temperature for 30 min. Afterwards, the urea was broken up in pieces of 1-6 mm and stored in closed polyethylene bottles at 40° C. Samples were taken monthly for 6 months and analyzed for active ingredient concentration. From each sample 2×15 g was dissolved in 100 mL water and analyzed using HPLC method DIN_EN_16651. The resulting NxPT concentrations from both measurements were averaged.

The graphs of FIG. 4 shows that formulations with 75% and 90% DEG, which were added to the urea melt, show better NxPT stability during storage of treated urea, compared to the formulation with 50% DEG. Therefore, a DEG/NxPT ratio of >1 is advantageous.

### Example 4

Formulations of NBPT and NPPT in DEG with additional amine were prepared as shown in Table 2 below.

TABLE 2
Ingredients of urease inhibitor formulation
comprising an additional amine.

| | Formulation composition (g) | | | | |
|---|---|---|---|---|---|
| | NBPT | NPPT | DEG | DEIPA | PEI |
| F8 | 300 | 100 | 537.5 | 62.5 | |
| F9 | 300 | 100 | 537.5 | | 62.5 |

In a test plant, urea was granulated in a fluidized bed granulator having a cylindrical fluidized bed of diameter 40 cm at a temperature of about 108° C. The fluidized bed was concluded at its lower end by a perforated plate, the holes of which had a diameter of 2.0 mm. The fluidization air flowed at a superficial flow rate of about 2 m/s into the fluidized bed. An overflow was mounted 10 cm above the baseplate at the side wall of the bed. A defined amount (about 30 kg) of urea particles or urea granules having a narrow size distribution was then introduced into the granulator column as seeds for the granulation. The bed with the seeds (about 50 cm deep) was fluidized with hot air at a temperature of about 100° C., and the addition of 96 to 97% by weight urea solution at a temperature of about 135° C. was commenced as soon as the bed had reached the temperature of about 108° C. that was envisaged for the run. From a reservoir tank, the urea solution having a water content of 3-4% by weight was then introduced into the fluidized bed granulator at a rate of 300 kg/h via a spray nozzle that was operated at a temperature of about 140° C. with air, supplied at a rate of 240 kg/h. Urease inhibitor formulation was continuously pumped into the urea stream fed to the nozzle prior to spraying at a rate to achieve an active ingredient concentration (NBPT+NPPT) in the final urea product of 0.055 wt.-%. Solids were discharged from the fluidized bed via an outlet at regular intervals of 5 minutes in order to achieve a largely constant height of the bed. The duration per batch was about 30 minutes in each case. After this time had elapsed, the feed was stopped, the granular material was cooled down to about 100° C. and removed from the fluidized bed granulator, and it was separated by sieving it into the different fractions. The fraction having the desired size distribution was then cooled down to room temperature in order to analyze the product properties thereof.

Samples of the resulting urea granules were stored in closed polyethylene bottles at 20° C., 30° C. and 40° C. Samples were taken after 0, 1, 2, 3, 4, 6, and 12 months and analyzed for active ingredient concentration. From each sample 2×15 g was dissolved in 100 mL water and analyzed using HPLC method DIN_EN_16651. The resulting NxPT concentrations from both measurements were averaged.

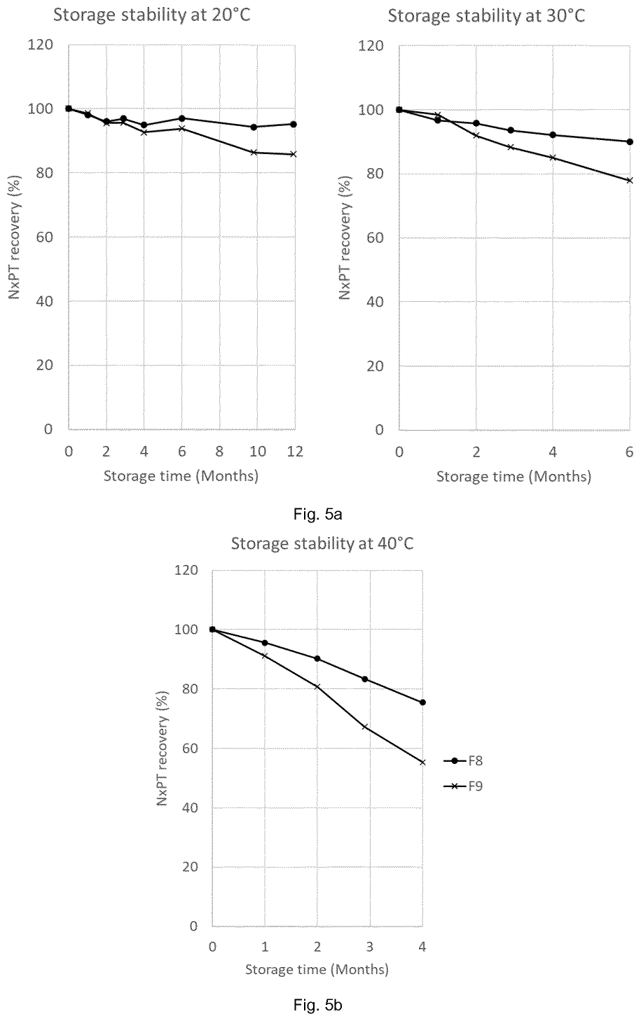

As can be seen in the graphs of FIGS. 5a and 5b, samples containing DEIPA showed surprisingly a higher storage stability in urea compared to samples containing PEI, in particular, when compared to Example 5.

### Example 5

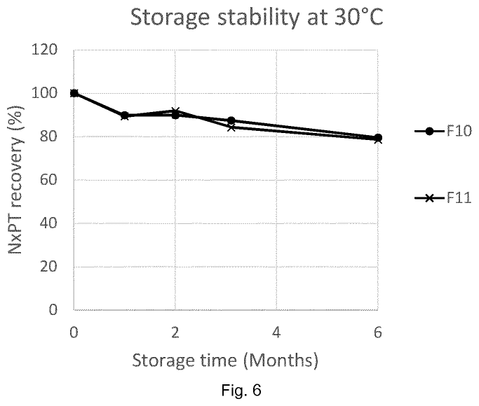

3 kg of urea fertilizer granules were added to an ERWEKA mixer (dimensions mix drum: 50 cm diameter, 20 cm high). The mixer was turned on (27 RPM) and the respective amount of urease inhibitor formulation (formulations of NBPT and NPPT in DEG with additional amine were prepared as shown in Table 3 below) was sprayed onto the urea using a syringe to achieve a total NxPT concentration of 550 ppm (137.5 ppm NPPT and 412.5 ppm NBPT) on urea. The fertilizer/urease inhibitor mixture was mixed for 5 minutes. Afterwards, the treated urea was stored in closed polyethylene bottles at 30° C. Samples were taken after 1, 2, 3 and 6 months and analyzed for active ingredient concentration. From each sample 2×15 g was dissolved in 100 mL water and analyzed using HPLC method DIN_EN_16651. The resulting NxPT concentrations from both measurements were averaged. The results in FIG. 6 show that both DEIPA and PEI show the same performance when used in urease inhibitor formulations which are applied as coating to urea.

Hence, DEIPA and PEI both have a stabilizing effect.

TABLE 3
Ingredients of urease inhibitor formulation
comprising an additional amine.

| | Formulation composition (g) | | | | |
|---|---|---|---|---|---|
| | NBPT | NPPT | DEG | DEIPA | PEI |
| F10 | 18.75 | 6.25 | 68.75 | 6.25 | |
| F11 | 18.75 | 6.25 | 68.75 | | 6.25 |

1. A solid composition (1) comprising
(A) a mixture comprising N-(n-butyl)thiophosphoric acid triamide (NBPT) and optionally N-(n-propyl)thiophosphoric acid triamide (NPPT);
(B) a solvent, wherein the solvent (B) is a glycol ether;
(C) urea; and
(D) at least one amine selected from the group consisting of
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²
(D4) an amine containing at least one saturated or unsaturated C₈ to C₄₀ alkyl group R²³, and
(D5) a saturated or unsaturated heterocyclic amine which contains at least one oxygen atom as ring atom and which does not contain a further alkoxy group,
wherein the solid composition (1) is polymer free.

2. The solid composition (1) according to claim 1,
wherein the solvent (B) has a flashpoint (determined according to ISO 2719:2016) of more than 130° C.

3. The solid composition (1) according to claim 1, wherein the at least one amine is
(D2) an amine containing not more than one amino group and at least three hydroxy-substituted C₂ to C alkyl groups R²¹, wherein at least one of the groups R²¹ is different to the other groups R²¹.

4. The solid composition (1) according to claim 1,
wherein a weight ratio of the solvent (B) to a sum of N-(n-butyl)thiophosphoric acid triamide (NBPT) and N-(n-propyl)thiophosphoric acid triamide (NPPT) is from 1.1:1 to 50:1; and/or
wherein a weight ratio of N-(n-butyl)thiophosphoric acid triamide (NBPT) to N-(n-propyl)thiophosphoric acid triamide (NPPT) is from 0.5:1 to 30:1; and/or
wherein the solid composition (1) comprises a sum of N-(n-butyl)thiophosphoric acid triamide (NBPT) and N-(n-propyl)thiophosphoric acid triamide (NPPT) in an amount of 100 to 1000 ppm.

5. The method for stabilizing at least one (thio)phosphoric acid triamide in a solid composition (1) comprising a mixture (A) comprising the at least one (thio)phosphoric acid triamide, urea, and a glycol ether, wherein the solid composition (1) is obtained by mixing a composition (2) comprising the solvent and the at least one (thio)phosphoric acid triamide with a composition (3) comprising molten urea, and subsequent cooling.

6. The method according to claim 5,
wherein the composition (2) comprises the at least one (thio)phosphoric acid triamide in an amount of 5 to 60 wt.-%, based on the total weight of the composition (2); and/or the glycol ether in an amount of 40 to 95 wt.-%, based on the total weight of the composition (2).

7. The method according to claim 5,
wherein the glycol ether is selected from the group consisting of diethylene glycol, dipropylene glycol, triethylene glycol, di-ethyleneglycol monobutylether, triethyleneglycol-n-butylether, and mixtures thereof.

8. The method according to claim 5,
wherein the solvent has a flashpoint (determined according to ISO 2719:2016) of more than 130° C.

9. The method according to claim 5,
wherein the mixture (A) comprises at least one (thio)phosphoric acid triamide according to general formula (I) 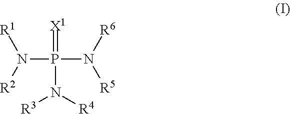
wherein
X¹ is O or S;
R¹ is C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl;
R² is H, C₁-C₂₀-alkyl, C₃-C₂₀-cycloalkyl, C₆-C₂₀-aryl, C₆-C₂₀-aryl-C₁-C₄-alkyl, or C₁-C₆-(di)alkylaminocarbonyl; or
R¹ and R² together with the nitrogen atom linking them define a 5- or 6-membered saturated or unsaturated heterocyclic radical, which optionally comprises 1 or 2 further heteroatoms selected from the group consisting of N, O, and S; and
R³, R⁴, R⁵, and R⁶ are independently of each other selected from the group consisting of H and C₁-C₄-alkyl.

10. The method according to claim 5,
wherein at least 50 wt.-% of the at least one (thio)phosphoric acid triamide is stable over a period of two months storage at 40° C. and/or
wherein at least 50 wt.-% of the at least one (thio)phosphoric acid triamide is stable over a period of six months storage at 30° C.

11. The method according to claim 5,
wherein the solid composition (1) further comprises
(D) at least one amine selected from the group consisting of
(D1) a polymeric polyamine,
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²,
(D4) an amine containing at least one saturated or unsaturated C₈ to C₄₀ alkyl group R²³, and
(D5) a saturated or unsaturated heterocyclic amine which contains at least one oxygen atom as ring atom and which does not contain a further alkoxy group.

12. A process of manufacturing a solid composition (1) comprising
a) dissolving at least one (thio)phosphoric acid triamide in a solvent selected from the group consisting of glycol ethers to obtain a composition (2);
b) heating urea to a temperature of 125 to 145° C. to obtain a composition (3);
c) mixing the composition (2) and the composition (3);
d) cooling the mixture obtained in step c) to a temperature of 20 to 30° C., wherein the cooling is done in a granulation apparatus, a prilling apparatus, pelleting apparatus, a pastilling apparatus, or compounding apparatus to form the solid composition (1),
wherein the solid composition (1) further comprises
(D) at least one amine selected from the group consisting of
(D2) an amine containing not more than one amino group and at least three alkoxy- or hydroxy-substituted C₂ to C₁₂ alkyl groups R²¹, wherein at least one of the groups R²¹ is different to the other groups R²¹,
(D3) an amine containing not more than one amino group and at least two alkoxy- or hydroxy-substituted C₂ to C₁₂ alkyl groups R²², wherein at least one of the groups R²² bears the alkoxy or hydroxy substituent at a secondary or tertiary carbon atom and wherein at least one of the groups R²² is different to the other group(s) R²²
(D4) an amine containing at least one saturated or unsaturated C₈ to C₄₀ alkyl group R²³, and
(D5) a saturated or unsaturated heterocyclic amine which contains at least one oxygen atom as ring atom and which does not contain a further alkoxy group.

13. The process according to claim 12, wherein the mixing in step c) is performed from 1 second to 5 minutes.

14. The process according to claim 12, wherein the solid composition (1) is in the form of granules, prills, pellets, pastilles, or in compounded form.

15. A solid composition (1) obtained by a process according to claim 12.

16. (canceled)

17. The solid composition (1) according to claim 1 wherein the glycol ether is selected from the group consisting of diethylene glycol, dipropylene glycol, triethylene glycol, di-ethyleneglycol monobutylether, triethyleneglycol-n-butylether, and mixtures thereof.

18. The solid composition according to claim 17 wherein the glycol ether is diethylene glycol.

19. The solid composition (1) according to claim 3 wherein the amine is bis(hydroxyethyl)-isopropanolamine (DEIPA).
